(19) United States
(12) Patent Application Publication
(10) Pub. No.: US 2026/0178012 A1
(43) Pub. Date: Jun. 25, 2026

(54) SERVICE PROVIDING DEVICE, SERVICE PROVIDING SYSTEM, AND COMPUTER-READABLE RECORDING MEDIUM

(71) Applicant: FANUC CORPORATION, Yamanashi (JP)

(72) Inventor: Hideo OGINO, Yamanashi (JP)

(21) Appl. No.: 18/727,339

(22) PCT Filed: Jan. 19, 2022
(86) PCT No.: PCT/JP2022/001857

§ 371 Date: Jul. 9, 2024

(51) Int. Cl. G05B 19/418

(52) U.S. Cl. CPC G05B 19/4183; G05B 19/4184

(57) ABSTRACT

A service providing device according to the present disclosure includes: a request accepting unit that accepts request information at least including machine-specific information that uniquely identifies an industrial machine and requested service information that specifies a service desired to be used in the industrial machine; a determining unit that determines a recommended service recommended to be used in conjunction with the service desired to be used, on the basis of service combination information defining a combination of services that become suitable by being used in conjunction with each other among services that can be provided, service trial information related to a service provided by the industrial machine as trial, and the request information; and a service information providing unit that notifies information for providing trial of the recommended service determined by the determining unit under a predetermined trial condition.

### RELATED APPLICATIONS

The present application is a National Phase of International Application No. PCT/JP2022/001857 filed Jan. 19, 2022.

### TECHNICAL FIELD

The present invention relates to a service provision device, a service provision system, and a computer-readable recording medium.

### BACKGROUND ART

Industrial machines and service provision devices thereof provide and realize a broad range of services (functions of machines). Generally, a user purchases a necessary service.

The purchased service is configured to be enabled upon shipment or after shipment of the industrial machine.

Thereafter, the service can be used on a permanent basis (for example, refer to PTL 1 or the like).

### CITATION LIST

### Patent Literature

[PTL 1] Japanese Patent Application Publication No. H07-234714

### SUMMARY OF INVENTION

### Technical Problem

Some functions of machines are solely capable of eliciting sufficient effects. In such cases, a user can consider introducing the function from the outset. On the other hand, there are functions expected to provide even better usability, improved machining quality, and also provide reduced cycle time in machining, and the like when used in combination with other functions. An effect elicited by such a combination of functions can be ascertained only through concomitant use. However, unless the user is aware of that, the user will not consider concurrently introducing such functions. In addition, the reality is that even if the user is aware of that, it is difficult to determine whether or not to expend the introduction cost at a timing where the user is unsure as to whether or not sufficient advantages can be enjoyed through the user's usage and, therefore, the functions cannot be readily trialed.

While the introduction of such functions can conceivably be supported by a machine function service provider, it is not easy to ascertain a situation of a machine user and it is difficult to effectively promote sales of function services. A sales representative of a machine manufacturer has to visit a site of a machine user to ascertain machining content, machine usage conditions, requests, and the like. This is incurred by the machine manufacturer as a cost.

In consideration thereof, a technical scheme for proposing an effective service in response to machine usage conditions, requests, and the like of a user is desired.

### Solution to Problem

A service provision device according to the present invention solves the problem described above by enabling a service (function) of a machine to be used for a predetermined period of time thereby recommending a trial use of the service when adding the service so as to prompt a machine user to effectively use and try out a service which has remained unused by the machine user and so as to enable sales promotion of a service provided by a service provider (a manufacturer/distributor of an industrial machine/control device).

In addition, an aspect of the present disclosure is a service provision device of an industrial machine for providing, on a trial basis, services that can be provided by the industrial machine, the service provision device including: a request accepting unit which accepts request information including at least machine-specific information that uniquely identifies the industrial machine and requested service information that designates a service intended to be used in the industrial machine; a determining unit which determines a recommended service, of which concomitant use with the service intended to be used is recommended, based on service combination information that defines a combination of services that become suitable through concomitant use among the services that can be provided, service information related to a service provided on a trial basis by the industrial machine, and the request information; and a service information providing unit which notifies information for providing, on a trial basis, the recommended service determined by the determining unit under predetermined trial conditions.

Another aspect of the present disclosure is a service provision system of an industrial machine for providing, on a trial basis, services that can be provided by the industrial machine, wherein a service provision device manages at least one industrial machine that implements the service, and the industrial machine outputs the request information to the service provision device and provides the service on a trial basis, based on a result of a determination by the determining unit of the service provision device with respect to the request information.

Another aspect of the present disclosure is a computer-readable recording medium on which is recorded a program for causing a computer to operate as a service provision device of an industrial machine for providing, on a trial basis, services that can be provided by the industrial machine, wherein the program recorded in the computer-readable recording medium causes the computer to operate as: a request accepting unit which accepts request information including at least machine-specific information that uniquely identifies the industrial machine and requested service information that designates a service intended to be used in the industrial machine; a determining unit which determines a recommended service, of which concomitant use with the service intended to be used is recommended, based on service combination information that defines a combination of services that become suitable through concomitant use among the services that can be provided, service information related to a service provided on a trial basis by the industrial machine, and the request information; and a service information providing unit which notifies information for providing, on a trial basis, the recommended service determined by the determining unit under predetermined trial conditions.

### Advantageous Effect of Invention

According to an aspect of the present disclosure, in a case where there is a service that can be more suitable for machining by using concomitantly with a requested service, since a machine user can be informed that there is such a service, whereby effective use of the service is promoted.

### BRIEF DESCRIPTION OF DRAWINGS

FIG. 1 is a schematic hardware configuration diagram of a service provision device according to an embodiment of the present invention.

FIG. 2 is a block diagram showing schematic functions of a service provision device according to a first embodiment of the present invention.

FIG. 3 is a diagram showing an example of request information.

FIG. 4 is a diagram showing an example of service information.

FIG. 5 is a diagram showing an example of service combination information.

FIG. 6 is a diagram showing an example of a determination result with respect to a request.

FIG. 7 is a diagram showing an example of service information having been updated due to start of a trial.

FIG. 8 is a diagram showing an example of a screen displayed at end of a trial.

FIG. 9 is a block diagram showing schematic functions of a service provision device according to a second embodiment of the present invention.

FIG. 10 is a diagram showing another example of service combination information.

FIG. 11 is a block diagram showing schematic functions of a service provision device according to another embodiment.

### DESCRIPTION OF EMBODIMENTS

Hereinafter, embodiments of the present invention will be described together with the drawings.

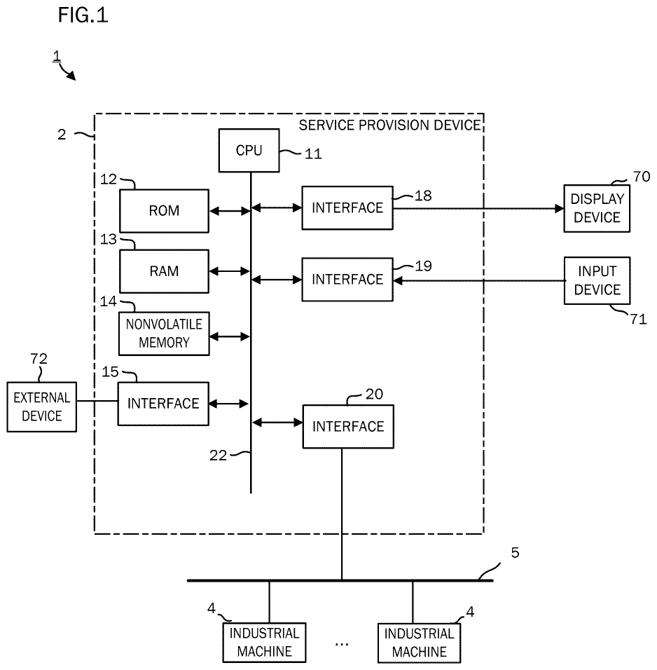

FIG. 1 is a schematic hardware configuration diagram showing a substantial part of a service provision device according to an embodiment of the present invention. A service provision device 2 according to the present invention is connected via a network 5 such as the Internet to industrial machines 4 which are machine tools, robots, or the like installed in a factory. The service provision device 2 manages the industrial machines 4 so as to constitute a service provision system 1. The service provision device 2 can be implemented on a computer such as a server. Software related to services that can be used is preinstalled in the industrial machines 4 according to the present embodiment. Moreover, it is assumed that the industrial machines 4 are configured so that functions thereof can be used by receiving information about predetermined use permission from the service provision device 2.

A CPU 11 included in the service provision device 2 according to the present invention is a processor which entirely controls the service provision device 2. The CPU 11 reads, via a bus 22, a system program stored in a ROM 12 and controls the entire service provision device 2 according to the system program. A RAM 13 temporarily stores temporary computational data, display data, and various kinds of data input from the outside.

A nonvolatile memory 14 is constituted of, for example, a memory, an SSD (Solid State Drive), or the like backed up by a battery (not illustrated) and a storage state of the nonvolatile memory 14 is retained even when power of the service provision device 2 is turned off. The nonvolatile memory 14 stores data and a machining program that are read from an external device 72 via an interface 15, data and a program that are input through an input device 71, and respective pieces of data having been transmitted from the industrial machines 4. The data and the machining program that are stored in the nonvolatile memory 14 may be expanded in the RAM 13 when being executed/used. In the ROM 12, various system programs such as known analyzers are written in advance.

The interface 15 is an interface for connecting the CPU 11 of the service provision device 2 and the external device 72 that is a USB device or the like to each other. For example, a program related to functions of the service provision device 2 or various kinds of data related to the provision of services can be read from the external device 72. Furthermore, programs and various kinds of data having been edited in the service provision device 2 can be stored in external storage means through the external device 72.

Respective pieces of data loaded onto the memory and data obtained as a result of executing a machining program, a system program, and the like are output to and displayed on a display device 70 via an interface 18. In addition, the input device 71 constituted of a keyboard, a pointing device, and the like supplies the CPU 11 with a command, data, and the like based on an operation by an operator via an interface 19.

An interface 20 is an interface for connecting the CPU 11 of the service provision device 2 and the network 5 to each other. The network 5 may be a WAN (Wide Area Network) constituted by a dedicated line or a wide area network such as the Internet. The industrial machines 4 which are machine tools, robots, or the like installed in a factory or the like and a fog computer, a cloud server, and the like which are not illustrated are connected to the network 5. The respective devices exchange data with the service provision device 2 via the network 5.

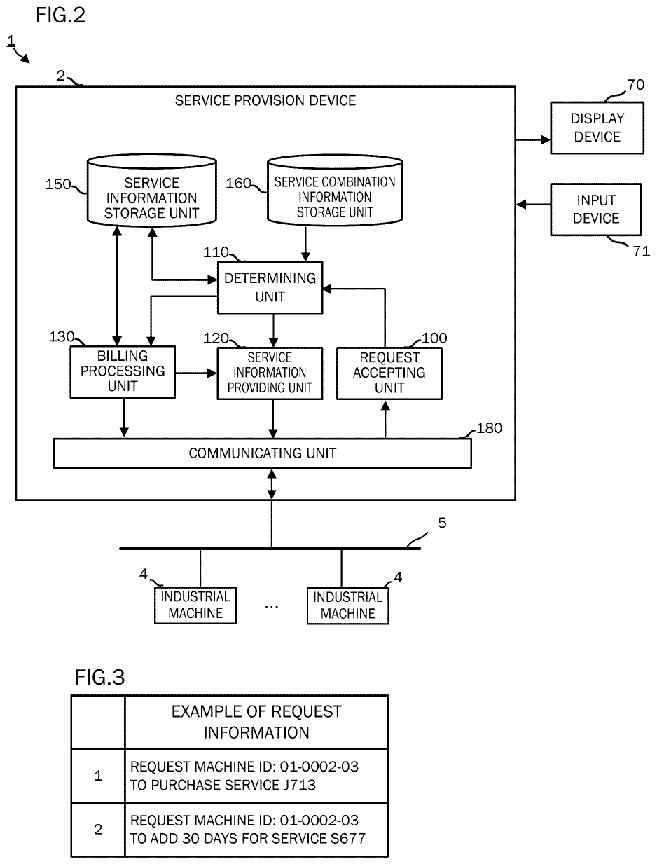

FIG. 2 shows functions included in the service provision device 2 according to the first embodiment of the present invention as a schematic block diagram. The respective functions of the service provision device 2 according to the present embodiment are implemented by having the CPU 11 included in the service provision device 2 illustrated in FIG. 1 execute a system program and control operations of respective units of the service provision device 2.

The service provision device 2 according to the present embodiment includes a request accepting unit 100, a determining unit 110, a service information providing unit 120, a billing processing unit 130, and a communicating unit 180. In addition, a service information storage unit 150 which is an area for storing service information that is information related to a state of provision of a service in each industrial machine 4 and a service combination information storage unit 160 which is an area for storing service combination information that is information related to a combination of services providable by the industrial machine 4 are prepared in the RAM 13 or the nonvolatile memory 14 of the service provision device 2.

The request accepting unit 100 accepts request information related to services used in the industrial machines 4. The request information includes at least machine-specific information capable of uniquely identifying industrial machines 4 managed by the service provision device 2 and requested service information capable of uniquely identifying the requested service. The request accepting unit 100 outputs the accepted request information to the determining unit 110.

The machine-specific information may be structured in any way as long as at least the industrial machine 4 being managed can be uniquely identified. For example, the machine-specific information may include information for uniquely identifying a Machine Tool Builder (for example, a Machine Tool Builder number or the like), information for uniquely identifying a user using the industrial machine 4 (for example, a machine user number or the like), information for uniquely identifying the industrial machine 4 owned by the user (for example, a serial number), and the like.

The requested service information may be structured in any way as long as at least a service (function) that can be used in the industrial machine 4 managed by the service provision device 2 can be uniquely identified. For example, the requested service information may be a name of the function to be requested, an assigned service number, or the like. Examples of a service that can be used in the industrial machine 4 include services in which a machine tool or a robot is used for drive control or other services related to such services. The requested service information may further include information indicating a mode of provision of a service. Examples of a mode of provision include a mode of purchase, a mode of subscription with a designated period, and a mode of subscription with a designated frequency of use.

FIG. 3 is a diagram showing an example of request information. A first piece of request information includes machine ID: 01-0002-03 as machine-specific information, service number: J713 as requested service information, and information expressed as mode of provision: purchase. A second piece of request information includes machine ID: 01-0002-03 as machine-specific information, service number: S677 as requested service information, and information expressed as mode of provision: add 30 days.

The determining unit 110 determines a recommended service that can be additionally recommended with respect to a request from the industrial machine 4 based on request information accepted by the request accepting unit 100 from the industrial machine 4, service information stored in the service information storage unit 150, and service combination information stored in the service combination information storage unit 160.

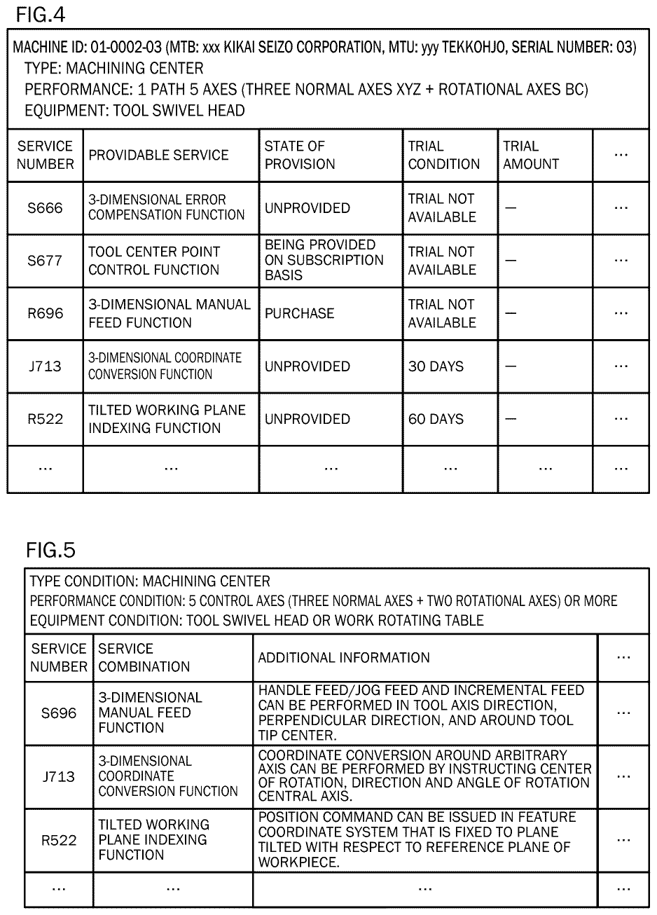

When request information of the industrial machine 4 is input from the request accepting unit 100, the determining unit 110 reads, from the service information storage unit 150, service information corresponding to the machine-specific information included in the request information. In addition, the determining unit 110 determines whether or not the requested service can be provided. FIG. 4 shows an example of service information stored in the service information storage unit 150. Service information is information for managing services by associating at least information related to the provision of the service with each piece of machine-specific information. The information related to the provision of the service which is included in the service information includes a state of provision, information indicating a trial condition, and information indicating an amount of trials with respect to each service. In the example shown in FIG. 4, in the industrial machine 4 with machine ID: 01-0002-03, a tool center point control function with service number: S677 is provided in the form of a subscription and a 3-dimensional manual feed function with service number: R696 is provided in the form of purchase. In addition, a 3-dimensional error compensation function with service number: S666, a 3-dimensional coordinate conversion function with service number: J713, and a tilted working plane indexing function with service number: R522 are in an unprovided state. As the trial condition, information indicating an availability of a trial, a trial time limit, a trial period, a trial frequency when a trial is available, or the like is set. In the example shown in FIG. 4, trials are not available for the 3-dimensional error compensation function, the tool center point control function, and the 3-dimensional manual feed function, a trial is available for the 3-dimensional coordinate conversion function for only 30 days, and a trial condition of 60 days is set for the tilted working plane indexing function. An amount of trials is information for managing a remaining trial period or a remaining trial frequency with respect to a service being trialed. Necessary information such as a trial start date may be further managed as service information. As illustrated in FIG. 4, service information may include information related to an attribute of the industrial machine 4. For example, information related to the attribute of the industrial machine 4 includes a type of the industrial machine 4 (a machining center, a lathe, or the like), performance of the industrial machine 4 (number of controlled axes, number of paths, maximum number of revolutions of spindle, or the like), and equipment provided in the industrial machine 4 (tool swivel head, cutting fluid-related equipment, work supply device, automatic chip discharge device, or the like). The example in FIG. 4 shows that the type of the industrial machine 4 with machine ID: 01-0002-03 is a machining center of which performance is one-path five-axes (three normal axes XYZ and rotational axes BC) and which is equipped with a tool swivel head as equipment. Based on such service information, the determining unit 110 determines that a service in a providable state such as an unprovided function, a function currently being trialed, or a function being provided on a subscription basis can be provided.

Next, the determining unit 110 reads service combination information corresponding to the requested service information included in the request information from the service combination information storage unit 160. Subsequently, the determining unit 110 determines whether or not the requested service can be used in the industrial machine 4. In addition, the determining unit 110 determines whether or not there is a service that can be concomitantly used with the requested service. FIG. 5 shows an example of service combination information that is stored in the service combination information storage unit 160. As illustrated in FIG. 5, service combination information includes a condition of the industrial machine 4 which is capable of providing the service and a list of services that can be provided in combination of each other. The condition of the industrial machine 4 which is capable of providing the service may include a condition of a type, a condition of performance, and a condition of equipment of the industrial machine 4 which is capable of providing the service. In the example shown in FIG. 5, the services included in the service combination information are conditioned to be usable in industrial machines of which a type is a machining center, performance is five controlled axes (three normal axes and two rotational axes) or more, and equipped with a tool swivel head or a work rotating table. The list of services included in the service combination information is a list of a plurality of services that can be more suitably used through concomitant use as compared to individual use such as a service which becomes more usable, a service which improves machining quality, or a service which reduces cycle time in machining. In the example shown in FIG. 5, the 3-dimensional manual feed function, the 3-dimensional coordinate conversion function, and the tilted working plane indexing function are respectively registered as services which can be more suitably used through concomitant use. As illustrated in FIG. 5, service combination information may include feats that can be achieved by each service as additional information. By referring to such service combination information, the determining unit 110 determines that the industrial machine 4 with machine ID: 01-0002-03 satisfies type condition, performance condition, and equipment condition. In addition, the determining unit 110 determines that the 3-dimensional coordinate conversion function that is the requested service and the 3-dimensional manual feed function and the tilted working plane indexing function can be concomitantly used in a suitable manner.

The determining unit 110 determines whether or not there is a service not provided in the industrial machine 4 corresponding to the machine-specific information included in the request information among services that can be concomitantly used with the requested service. In addition, the determining unit 110 determines that the unprovided service is a recommended service. For example, in the industrial machine 4 with machine ID: 01-0002-03 illustrated in FIG. 4, the 3-dimensional manual feed function is already being used in a purchased state. On the other hand, the tilted working plane indexing function is in an unprovided state and is currently unused. In such a case, the determining unit 110 determines that the tilted working plane indexing function is a recommended service.

The determining unit 110 updates the service information stored in the service information storage unit 150 based on the result of determination. For example, the determining unit 110 updates a state of provision of the service requested in the request information in accordance with a provision mode. In addition, the determining unit 110 updates a state of provision of the recommended service to trial being provided.

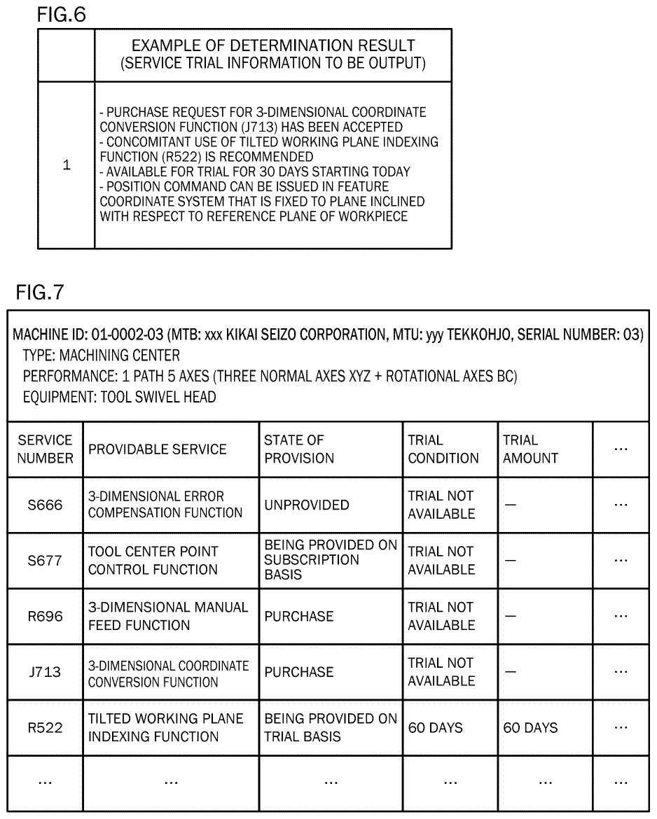

FIG. 6 is a diagram showing an example of a determination result by the determining unit 110. When the request accepting unit 100 accepts the first request illustrated in FIG. 3 in the event that the service information storage unit 150 stores the service information illustrated in FIG. 4, the determining unit 110 reads service information of machine ID: 01-0002-03 from the service information storage unit 150 and refers to information of service number: J713. Since a present state of provision of the service with service number J713 is found to be unprovided, as illustrated in FIG. 6, the determining unit 110 determines that a purchase of the 3-dimensional coordinate conversion function is to be accepted. In addition, the determining unit 110 reads service combination information including service number: J713 such as illustrated in FIG. 5 from service combination information storage unit 160. In addition, the determining unit 110 determines that the tilted working plane indexing function with service number: R522 can be recommended. Furthermore, from service information and service combination information, the determining unit 110 determines that the tilted working plane indexing function can be trialed for a maximum of 60 days and that the function has additional information that reads “a position command can be issued in a feature coordinate system fixed to a plane that is inclined with respect to a reference plane of a workpiece”. Based on these determination results, service information of machine ID: 01-0002-03 is updated as illustrated in FIG. 7.

Service information providing unit 120 provides the industrial machine 4 with the determination result by the determining unit 110. The provided determination result is handled as information about the permission of use or the prohibition of use of a predetermined service at the industrial machine 4. The determination result provided by the service information providing unit 120 includes at least information about whether or not the requested service can be provided and the conditions of provision of the service. The conditions of provision may include, for example, information about a remaining use period, a remaining user frequency, a trial time limit or a remaining trial period, a remaining trial frequency, or other information related to restrictions on use. In addition, the determination result may also include additional information and the like of the recommended service.

The billing processing unit 130 performs billing processing in accordance with the service to be provided based on the determination result by the determining unit 110. In the service information stored in the service information storage unit 150, information about billing corresponding to a form of service provision is preset for each service. Based on information related to billing, the billing processing unit 130 performs billing processing in accordance with a state of provision of each service. The billing processing unit 130 does not perform billing with respect to a service of which a provision mode is “trial being provided”.

The communicating unit 180 manages exchange of information via the network 5 between the service provision device 2 and the industrial machine 4. When receiving the request information from the industrial machine 4, the communicating unit 180 outputs the received request information to the request accepting unit 100. In addition, when the determination result with respect to the request information is output from the service information providing unit 120, the output determination result is transmitted to the industrial machine 4. Furthermore, the result of billing processing by the billing processing unit 130 is transmitted to the industrial machine 4. In addition to being transmitted to the industrial machine 4, the pieces of information may be transmitted to the user of the industrial machine 4 or the manufacturer of the industrial machine 4 via other communication means such as an email.

When there is a service that becomes more suitable for machining by being concomitantly used with the requested service, since the service provision device 2 according to the present embodiment configured as described above enables the machine user to be readily informed of the service and enables the machine user to trial the service, effective use of the service is promoted.

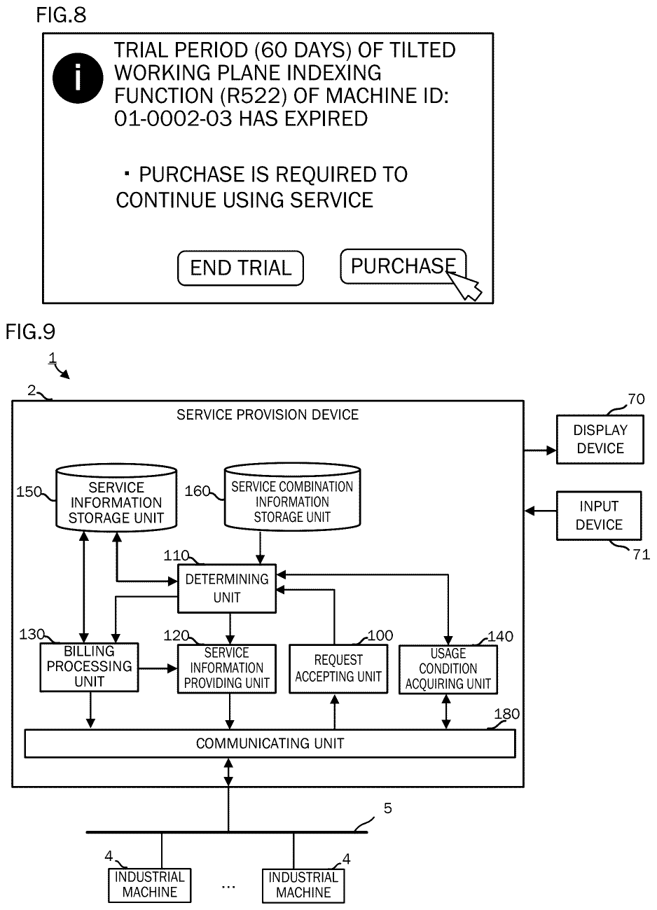

As a modification of the service provision device 2 according to the present embodiment, the service provision device 2 may output a warning to the user of the industrial machine 4 in accordance with a usage condition of the service being trialed. For example, with respect to a service of which a trial period is set, a trial amount which is a remaining trial period is managed. When there is a service of which the trial period has decreased to zero days, the service information providing unit 120 may transmit a warning message indicating that the remaining trial period has decreased to zero days to the user of the industrial machine 4. FIG. 8 is an example of the warning message that is transmitted to the user when the remaining trial period has decreased to zero days. By looking at the message, the user can be informed of the fact that the trial period of the tilted working plane indexing function has expired and can make a determination to purchase (buy, subscribe, or the like) the service for continuous use. When the user selects purchase, request information of the corresponding service is transmitted to the service provision device 2.

FIG. 9 shows functions included in a service provision device 2 according to a second embodiment of the present invention as a schematic block diagram. The respective functions of the service provision device 2 according to the present embodiment are implemented by having the CPU 11 included in the service provision device 2 shown in FIG. 1 execute a system program and control operations of respective units of the service provision device 2.

The service provision device 2 according to the present embodiment further includes a usage condition acquiring unit 140 in addition to the request accepting unit 100, the determining unit 110, the service information providing unit 120, the billing processing unit 130, and the communicating unit 180. In addition, the service information storage unit 150 which is an area for storing service information that is information related to a state of provision of a service in each industrial machine 4 and the service combination information storage unit 160 which is an area for storing service combination information that is information related to a combination of services providable by the industrial machine 4 are prepared in the RAM 13 or the nonvolatile memory 14 of the service provision device 2.

The request accepting unit 100, the service information providing unit 120, the billing processing unit 130, and the communicating unit 180 according to the present embodiment are similar to the respective functions in the first embodiment.

The usage condition acquiring unit 140 according to the present embodiment acquires information indicating a usage condition of the industrial machine 4 that is a management object. The usage condition of the industrial machine 4 acquired by the usage condition acquiring unit 140 may be, for example, the number of times of use or a use frequency of each service. In addition, the usage condition of the industrial machine 4 acquired by the usage condition acquiring unit 140 may be command contents of a machining program used in drive control of the industrial machine 4. The usage condition acquiring unit 140 may be configured to acquire information indicating the usage condition of the industrial machine 4 at predetermined periods. The usage condition acquiring unit 140 outputs, to the determining unit 110, acquired information indicating the usage condition of the industrial machine 4 at predetermined timings (daily, weekly, or the like) set in advance.

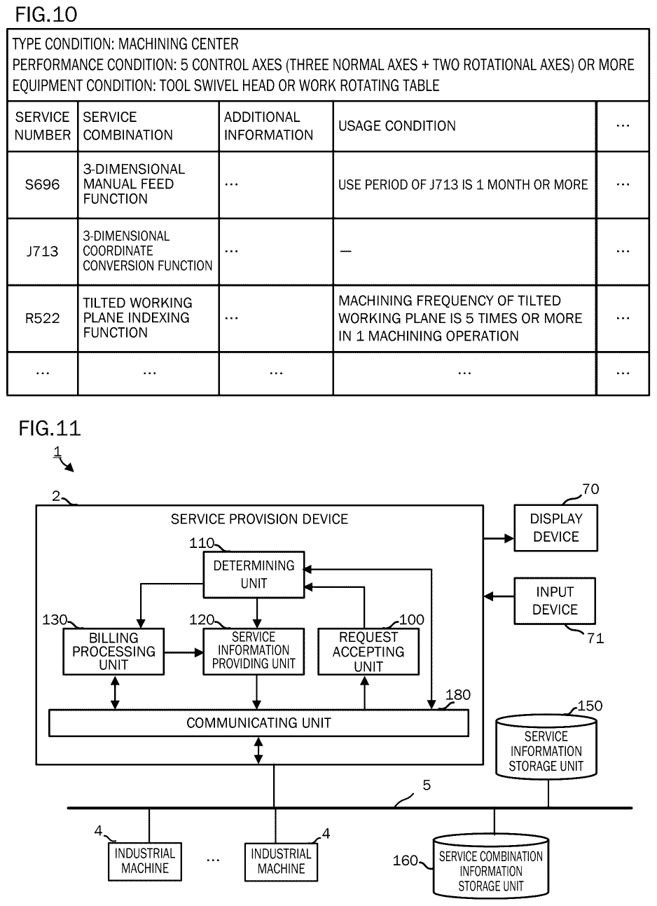

The determining unit 110 according to the present embodiment analyzes the information indicating the usage condition of the industrial machine input from the usage condition acquiring unit 140 and determines a service to be recommended to the user. FIG. 10 shows an example of service combination information stored in the service combination information storage unit 160 according to the present embodiment. Information indicating a condition of usage for recommending a trial of each service is set in the service combination information according to the present embodiment in association with the service. For example, it is shown that a condition of usage for recommending a trial of the 3-dimensional manual feed function with service number: S696 is one month or more from start of use of the 3-dimensional coordinate conversion function with service number: J713. The determining unit 110 refers to the usage condition of industrial machines 4 input from the usage condition acquiring unit 140, and when there is an industrial machine 4 which has been using the 3-dimensional coordinate conversion function for one month or more, the determining unit 110 determines that the 3-dimensional manual feed function is the recommended service of the industrial machine 4. A flow of providing the determined recommended service on a trial basis is similar to that of the service provision device 2 according to the first embodiment. In addition, for example, it is shown that a condition of usage for recommending a trial of the tilted working plane indexing function with service number R522 is that a machining frequency of the tilted working plane indexing is five times or more in one machining operation. The determining unit 110 refers to types of commands included in a program executed by each industrial machine 4 and to known results of machining simulations and determines that the tilted working plane indexing function is a recommended service of the industrial machine 4 when the number of times a surface that is inclined with respect to a linear axis is machined in one machining operation is five times or more. A flow of providing the determined recommended service on a trial basis is similar to that of the service provision device 2 according to the first embodiment.

When there is a service that can be effectively used in accordance with the usage condition of the industrial machines 4, since the service provision device 2 according to the present embodiment configured as described above enables a machine user to be readily informed of the service and also enables the machine user to trial the service, effective use of the service is promoted.

While embodiments of the present invention have been described above, the present invention is not solely limited to the embodiments described above and can be implemented in various aspects by making appropriate modifications.

For example, the service provision system 1 in the embodiments described above is configured such that the service information storage unit 150 and the service combination information storage unit 160 are built into the service provision device 2. However, as illustrated in FIG. 11, the service information storage unit 150 and the service combination information storage unit 160 may be provided on a computer that differs from the service provision device 2.

In addition, the service provision system 1 in the embodiments described above is configured such that the service provision device 2 and industrial machines are connected via a network. However, the service provision device 2 may be configured on a controller that controls the industrial machines 4. In this configuration, when a service is used at the industrial machines 4, request information is output to a functional group corresponding to the service provision device 2 configured on the controller. In addition, a determination result of the determining unit 110 is output as a response to the request information. Configuring the service provision device 2 on the controller allows even industrial machines 4 separated from the network to use the functions of the invention of the present application.

1. A service provision device of an industrial machine for providing, on a trial basis, services that can be provided by the industrial machine, the service provision device comprising:
a request accepting unit which accepts request information including at least machine-specific information that uniquely identifies the industrial machine and requested service information that designates a service intended to be used in the industrial machine;
a determining unit which determines a recommended service, of which concomitant use with the service intended to be used is recommended, based on service combination information that defines a combination of services that become suitable through concomitant use among the services that can be provided, service information related to a service provided on a trial basis by the industrial machine, and the request information; and
a service information providing unit which notifies information for providing, on a trial basis, the recommended service determined by the determining unit under predetermined trial conditions.

2. The service provision device according to claim 1, wherein
in the service combination information, a combination of services that can be concomitantly used is defined for each attribute of the industrial machine, the attribute being at least any of a type, performance, and equipment, and
the determining unit determines the recommended service based on an attribute of the industrial machine which is identified according to the machine-specific information accepted as request information.

3. The service provision device according to claim 1, wherein
the service information includes a trial condition of services that can be used in the industrial machine.

4. The service provision device according to claim 3, wherein
the trial condition includes at least any of information indicating an availability of a trial, a trial period, a trial time limit, and a trial frequency of the service.

5. The service provision device according to claim 1, wherein
when a service being trialed deviates from the trial condition, the service information providing unit stops the provision of the service on a trial basis and notifies information that prompts continuous use of the service.

6. The service provision device according to claim 1, wherein
the service of which a trial is available in the industrial machine is at least any of a function implemented by having a controller perform drive-control of a machine tool or a function implemented by having a robot controller perform drive-control of a robot.

7. The service provision device according to claim 1, further comprising
a usage condition acquiring unit which acquires a usage condition of the industrial machine, wherein
the determining unit determines, based on a usage condition of the industrial machine acquired by the usage condition acquiring unit, a recommended service to be recommended in the usage condition.

8. A service provision system of an industrial machine for providing, on a trial basis, services that can be provided by the industrial machine, wherein
the service provision device according to claim 1 manages at least one industrial machine that implements the service, and
the industrial machine
outputs the request information to the service provision device and
provides the service on a trial basis, based on a result of a determination by the determining unit of the service provision information with respect to the request information.

9. The service provision system according to claim 8, wherein
the service provision device and the industrial machine are connected to each other via a network, and
the industrial machine communicates with the service provision device via the network.

10. The service provision system according to claim 8, wherein
the service provision device is configured on a controller that controls the industrial machine.

11. A computer-readable recording medium on which is recorded a program for causing a computer to operate as a service provision device of an industrial machine for providing, on a trial basis, services that can be provided by the industrial machine, wherein the program recorded in the computer-readable recording medium causes the computer to operate as:
a request accepting unit which accepts request information including at least machine-specific information that uniquely identifies the industrial machine and requested service information that designates a service intended to be used in the industrial machine;
a determining unit which determines a recommended service of which concomitant use with the service intended to be used is recommended, based on service combination information that defines a combination of services that become suitable through concomitant use among the services that can be provided, service information related to a service provided on a trial basis by the industrial machine, and the request information; and
a service information providing unit which notifies information for providing, on a trial basis, the recommended service determined by the determining unit under predetermined trial conditions.
